(19) United States
(12) Patent Application Publication
(10) Pub. No.: US 2007/0299671 A1
(43) Pub. Date: Dec. 27, 2007

(54) METHOD AND APPARATUS FOR ANALYSING SOUND- CONVERTING SOUND INTO INFORMATION

(75) Inventors: Neil M. McLachlan, Clifton Hill (AU); Dinesh Kant Kumar, Balwyn North (AU)

Correspondence Address: Ms Ruchika Kapur;c/o Sanjiv Kapur, 1130, Kelton Blvd, Gulf Breeze, FL, 32563, US

(73) Assignee: Ruchika Kapur, Gulf Breeze, FL (US)

(21) Appl. No.: 11/164,553

(22) Filed: Nov. 29, 2005

(30) Foreign Application Priority Data
Mar. 31, 2004 (AU) 2004901712

(51) Int. Cl. G10L 19/00

(52) U.S. Cl. 704/500; 704/E19.001

(57) ABSTRACT

The present invention provides means of identifying a sound or acoustic event and converting this into suitable information for the user. This may be used for remote monitoring, for defense, for health applications, and for helping hearing impaired people for identifying the sounds. The system may also be used by a user for source of sound authentication/identification system and method, in which authentication of a user (if the purpose) is performed by verification of the voice of the user representing his or her biometrics, unique to a desired user. The audio data is not required to be stored for the purpose, instead the statistical properties of the temporal and spectral/wavelet coefficients or the weights of the trained neural network thus ensuring security of the data and small size of the stored data making it suitable for applications such as smart cards. The system is able to function in high noise environment, and when there may be multiple events overlapping.

This application claims the priority benefit of foreign (Australia) application—AU 2004901712, filed on 31^{st} Mar., 2004, the contents of which are hereby by reference.

The present invention relates to the field of identification acoustic events and converting these into other forms of signals with the aim of helping people with hearing impairments. Alternatively, this could also be used for remote monitoring of a space for defense or security applications.

In one form, the invention relates to the analysis of sound to identify events that can be recognized by sound or vibration. The present invention relates to sound analysis and classification where the sound may be below the hearing ability of the user, or may be at a remote location from where the user is unable to listen to the sound. While the applications may be very wide, the specific application discussed in this document is when this enhances the capability of the hearing impaired, or for the elderly, or for security.

It will be convenient to hereinafter describe the invention in relation to acoustic event identification, however it should be appreciated that the present invention is not limited to that use only.

### BACKGROUND ART

Hearing is one of the very important sensory inputs to us human. But for the people who are hearing impaired from birth, or have progressively had a reduction of their hearing abilities due to ageing and other reasons, the lack of ability to hear well is always an impediment. To overcome this shortcoming, hearing aids, and hearing aiding implants have been developed and are extensively used. But there are number of shortcomings with these systems such as convenience, lack of clarity, and lack of directionality of the source of sound.

Numbers of techniques are being used to improve the output of the hearing aids and similar devices. But despite the advances, it is important for the user to wear the device which is often not very convenient. What this invention is doing is identifying some of the important sounds and acoustic events that may be critical for the user, and then informing the user of these events in alternate ways.

In our modern life, the ability to hear is very critical for our safety also. Number of equipments in and around the house interacts with the user by giving audio alarms and other sounds. These include devices such as the kettle when the water boils, the oven at the end of the cooking cycle, the door bell when someone is at the door, the telephone, the smoke alarm, to name a few. While each of these devices can often be fitted with an alternate output that maybe suitable for the hearing impaired, this would require customization. It would also reduce the ability of the user who would either have to keep wearing the hearing aid, or would have to look at the device for the visual or similar information/alarm.

To identify the acoustic event or the sound, it is essential for the computer (or other) equipment to identify the event even when there are other sounds present, often with overlap. The computer classification of sound has been researched by parties interested in environmental acoustic logging, automated logging of music databases according to instrumentation, machine monitoring, military and other surveillance and speaker recognition systems.

The present inventors have identified that the most common approaches have been to apply statistical distance measures to band-limited or STFT (Short Time Fourier Transform) spectral data or cepstral coefficients. This approach has a number of disadvantages, such as the use of static spectrum for non-stationary signal, and the assumption that the difference between the signals is located in the higher energy content of the signal.

The inventor has also identified that heuristic methods have also been attempted for environmental sound analysis. To date few commercially viable products exist for these applications apart from relatively simple examples of machine monitoring which suffer from the disadvantage that these require extensive examples and supervision and require the source properties to be reasonably well known.

The inventor has also identified that speech (phoneme) recognition is another field in which many products are commercially available. In this field the range of sounds is restricted to the phonemes of a given language. These techniques use a combination of the spectral and temporal properties of the signal and STFT and wavelet analysis are commonly used to generate the time varying spectral data for classification by neural nets. Under good acoustic conditions these techniques can achieve accuracies of greater than 95% where a single person is speaking but tend to have a relatively lower accuracy when multiple persons are speaking. Thus, the practical implementation of this technology in an outdoor or acoustically complex environment is considered to be very limited.

The inventors have also identified that many prior art systems have a model-based approach to speech analysis. In these methods and systems, they base the analysis on making a mathematical model of the source and then determine the properties of the source that produce the sound. Examples are in automobile noise emission studies, and in human voice based Structured Audio (MPEG 2 and 4) or Linear Predictive Source Modeling used for mobile telephone compression. This model approach is considered to suffer from problems that the model of the source should be deterministic. This model is suitable for sound approximation and provides good compression but is not suitable for sound source authentication nor for sound classification.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to provide an improved sound classification and recognition method and system.

A further object of the present invention is to alleviate at least one disadvantage associated with the prior art.

A further object is to identify the common sounds in the household that require the attention of the occupant of the user, and with the help of a portable vibrator that is worn in a necklace or belt or similar object by the user, be informed of the event.

### SUMMARY OF INVENTION

The present invention provides, in one aspect, a method of and apparatus for identifying the source of sound or other similar signals by the use of statistical descriptions of the time, frequency analysis coefficients of the signal or a section of the signal.

The present invention provides a method of and apparatus for analyzing sound including the steps of providing a sample of sound, applying time-frequency analysis methods such as wavelet transforms or STFT, statistically analyzing the time-frequency coefficients, and defining the classes of sounds being analyzed using Neural Networks or statistical methods for the purposes of verifying the sound source. If required the method normalizes the amplitude of the sound samples before undertaking the time-frequency analysis. The statistical analysis of the time-frequency coefficients provides coefficients related to the time-averaged energy content within each frequency band and the range of energy fluctuation over the length of the sample within each frequency band.

The present invention also provides a method of and apparatus for analyzing sound, including the steps of providing a sample of sound, statistically analyzing the sample, and classifying the analyzed sample according to a band or bands of time-frequency coefficients that lie within a predetermined magnitude range. The selection of both the time-frequency coefficients used for the classification and the magnitude range in which these coefficients will be found for particular sound classes are iteratively determined during training of the system.

The present invention also provides a method of and apparatus for recording the sounds that require the attention of the user, including the steps of analyzing or identifying a sound sample as disclosed herein, comparing the analyzed sample against a reference sample, verifying whether or not the sound sample is substantially the same as the reference sample.

The present invention also provides means of changing the false positives and false negatives of the identification and thus provides means of selecting this choice with the help of supervisor information of the level of urgency required by the event.

Other aspects and preferred aspects are disclosed in the specification and/or defined in the appended claims, forming a part of the description of the invention.

In essence, the present invention stems from a hybrid approach incorporating Statistical analysis of wavelet coefficients and Neural networks. The present invention, in one aspect, uses an iterative technique and incorporates a neural network for classification of the statistical properties of the signal in a combination of time and frequency domains using multi-scale wavelet coefficients. After the invention identifies one event or sound, which maybe the background noise, it then subtracts the corresponding mean corresponding to this sound from the rest of the sound, to identify the presence of sounds it would have been trained to identify. This is one uniqueness of this invention, and thus it is able to identify a given sound even when the background noise, or sounds from other sources and events may be relatively strong. This is extremely important in the environments such as a kitchen. It is of great importance for other applications such as identification of environmental sounds, and for security applications.

The uniqueness of the invention is that it identifies a small list of important sounds that are relevant to a specific user, such as the kettle, the door bell, the telephone, etc, and recognizes these sounds while there maybe there sounds present.

The other uniqueness of the invention is that it identifies the sounds and events and gives it to the user who may be unable to hear these sounds due to the lack of (or reduced) ability, or due to these sounds being remote.

The uniqueness of the technique is that this does not model the source and look for identification features but develops a database of the source. A specific set of sounds of different events (spoken words by a user for example) would result in the system learning and storing the neural network weights after it is trained for the specific user. The statistical descriptors of the background noise/events would be stored and subtracted from the signal to determine the presence of the sound that needs to be identified.

The present invention has been found to result in a number of advantages, such as:

Low complexity of source data: The present invention requires a comparison of the statistical properties and weights of the neural network of the source and requires little if any information of the speaker's voice sample or information about the speech. The size of the stored file can be as small as 2 KB making it relatively convenient for being loaded on the smart cards, small memory chips or even some magnetic strips. This makes the present invention very suitable for security of all levels as it is considered virtually impossible to backwards engineer the voice or the text of the speaker from the weights of the network suitably classifying the statistical properties of the wavelet coefficients of the recording.

The present invention will identify the occurrence of the sounds and their temporal location, even in mixed and complex sounds. This makes it suitable for identification of the sounds that occur in noisy backgrounds such as a kitchen, or outdoor settings, such as urban traffic.

The present invention may use the complete word or group of words uttered (such as password or name of the speaker). This makes it very easy for the present invention to be trained for the new user, with or without the effort (knowledge) of the speaker over the telephone or similar.

The present invention is adjustable to the set of sounds to be classified both through parameters used in the sound feature extraction and through the use of a trained neural net signal classifier.

The present invention is able to identify the sounds even when there is noise.

The present invention is able to identify two overlapping sounds. In this situation, the invention would store the statistical descriptors of each of the sounds.

The present invention can also be used to classify groups of sounds as widely varying as noises such as wind and engine noise as well as information rich sounds like speech and music, or to classify relatively similar sounds such as groups of individual human voices speaking the same word. By neural network, we mean supervised neural network. Examples of this include the back propagation type neural networks.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawing, which is given by way of illustration only, and thus are not limitative of the present invention, and in which:

FIGS. 1 and 3 illustrates an embodiment of the present invention. FIG. 2 is an example of the system functionality.

### DETAILED DESCRIPTION

The present invention is a sound classification method system that applies statistical measures to wavelet coefficients of a sound sample for use in a neural net classifier. The system has to be trained to classify a finite set of sounds.

The present invention identifies the sound, and provides in near real time the information to the user that the user is most comfortable with, such as the use of a vibrator, or visual aid, or text message, or simply stored into a file.

The present invention subtracts the properties (statistical descriptors of the wavelet or similar coefficients) of the identified sound from the total sound, to determine the presence of another sound.

The present invention is thus able to identify a sound even when there is a high level of noise.

The present invention is distinguished from existing sound and speech recognition software by the particular statistical measures used. The present invention is adjustable to the set of sounds to be classified both through parameters used in the sound feature extraction and through the use of a trained neural net signal classifier. The present invention can be used to classify groups of sounds as widely varying as noises such as wind and engine noise to information rich sounds like speech and music, or to classify relatively similar sounds such as groups of individual human voices speaking the same word.

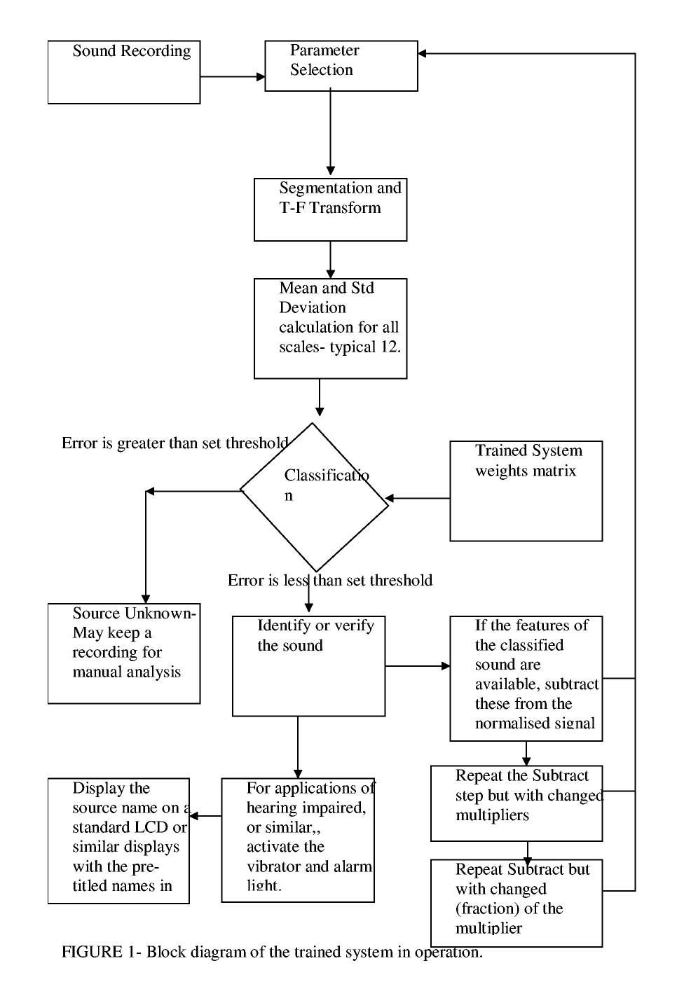

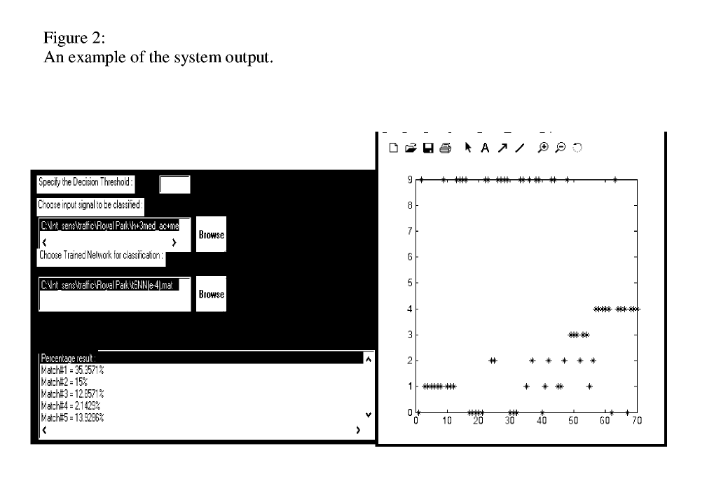

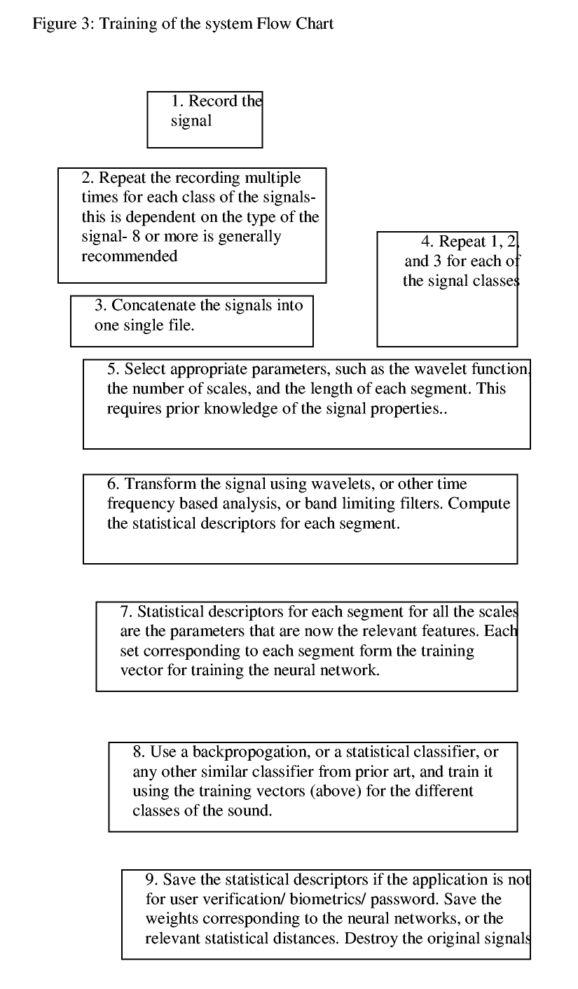

Turning to FIG. 1, a representation of the present invention is illustrated. A sound sample 1 is provided as an input for analysis. The sample is then iteratively analyzed 2. Studies on human recognition of environmental sounds have revealed that sounds are most distinguishable from a combination of spectral (frequency) and temporal features and based on the spectral energies, time varying behavior of these spectral components and statistical properties of the signals. In the present invention, it has also been identified that often the difference between two audio signals may lie in the component of the signal that has relatively small energy content. The present invention seeks to exploit this with the help of multi-resolution time-frequency attributes of wavelet transforms to extract statistical information about the distribution of energy across frequency bands and across the time of the sound sample. Lower frequency regions of the sound are well resolved in frequency but not so well in time, while higher frequency regions are well resolved in time but not frequency.

The output of the iterative analysis is provided to a neural network for classification 3. The neural network provides for a band threshold for coefficients with a lower and upper bound and determined by maximizing the statistical distance between the signals of different origin/source. Signals are classified to the source based on the band that best defines the values of the coefficients. The system provides the flexibility to select the narrowness of the signal classification band so that it may be used to determine an exact match or a wide match, depending on the application. The system does not need to store the entire signal but simply the values of the features mentioned above.

The statistical measures used are the mean of the coefficients and the variance/mean of the coefficients for each wavelet band over the time of the sample. The mean of the coefficient(s) are related to the time-averaged energy content in each band, while the variance/mean is related to the range of energy fluctuation over the length of the sample. In the one embodiment, 12 wavelet bands are used to cover the frequency range of 11-22,000 Hz. Extra low frequency bands can be included to capture slower variations of the sound envelope.

The sample to be classified, is then compared with a previously known sample 8 provided from a library of the various sounds and/or references with the help of the weighting matrix corresponding to the trained neural network of the sounds. Obviously the references or contents of the library will vary depending on the particular use of the present invention.

Certain criteria can be used in identifying or determining a match between the classified sample and the library sample. Such matching criteria may include setting a tolerance value in determining the requirement for an absolute match (allowing for a certain tolerance). The tolerance value may be preset or determined according to the application of the present invention.

If there is no match, an output unknown is given, whereas if a match is found, an appropriate output is given according to the matched class. Outputs may take many forms according to the intended application of the invention. For example if the application of the invention is to help the hearing impaired, a vibrator may be triggered and a text message may be sent to a mobile phone or palm computer in the possession of the user.

The present sound classification system has applications for alarm and information to the hearing impaired, for biometric, security monitoring and surveillance, remote machine monitoring and environmental acoustic monitoring.

This system is ideally suited for biometrics applications as it does not require the storage of the original sound making the system naturally encode the data. It also uses very small amount of memory and thus can be translated on a magnetic swipe card or similar cards and be used to gain entry into buildings, data or systems. This enables the use of a multi-tier security system, where once the card is passed through the reader the person is prompted to speak his/her name and/or a password into a microphone for computer recognition. This adds a measure of the identity of the person bearing the card.

For security monitoring this system enables video monitoring to be alerted and guided by the occurrence of specific sounds such as breaking glass or human distress calls. This will be important in cases where many locations are being monitored simultaneously and rapid responses are required. Surveillance methods can be partially automated by the use of this system to search and log audio-tapes generated over long surveillance periods. Remote machine monitoring can be facilitated by the improved discriminatory power of this system to detect the presence of, or changes to indicator sounds in the presence of other sounds.

The system has applications in environmental and traffic sound monitoring. The system is flexible and the user needs to train the system for the sounds that have to be monitored. Based on the thresholding and use of statistical features of the time and frequency components, the system will identify the combination of the features mentioned earlier to determine the occurrence of the sounds and the temporal location—even in mixed and complex sounds.

Other applications of the technology are in the field of vehicular maintenance (cars, planes and trams etc), where the sound of the engine and the body are often used by the mechanics to identify engine and body problems. These technologies provide a means for identifying problems in the vehicle and generate alerts for preventive maintenance. The system also provides to give an early warning for static machinery maintenance (electric power transformers) and for moving machinery such as motors, turbines, conveyers, etc.

The present invention is suitable for use in applications that can be broadly put in three categories:

(1) For monitoring of acoustic events such as the door bell, the fire alarm, the telephone, and the kettle in a kitchen, for the hearing impaired or similar people. The system will, in near real time, identify the presence of the sounds that can threaten the user, or are of other importance to the user, and give the information to the user in an alternative way. Thus, it will provide an alternate to the user having to wear the hearing aid all the time inside their home, especially when they are resting, or sleeping.

(2) Biometrics—for verification the identity of the person:

Confirming the identity of an individual over the telephone (such as for telephone banking).
Integrated with smart cards for the purpose of entry into an office or other such space or data or network.
Integrated with other biometrics technology for multiple tier security.
For accessing a computer in place of, or in conjunction with passwords.
For ensuring security of devices such as a mobile phone.
For automobile access and security.
   (3) Audio monitoring:
Of buildings—for identifying the time when certain, predefined audio events occurred-such as breaking of glass, voices of people, etc.
For telephone surveillance—for automatic identification of certain audio events such as the voice of an individual in a conversation.
   (4) Environmental and Noise monitoring:
For monitoring the street noise for better city noise management.
For monitoring audio events where there is a litigation related to noise between two people or groups.
For street barrier design and monitoring of road, aircraft and other transport noise.
For machine noise monitoring to pre-determine and thus prevent the possible engine/machine failure. This is based on the use of machine sound as a powerful and early indicator of machine defects.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

What is claimed is:

1. A method of classifying sounds or other similar signals by the use of statistical descriptions of the combined time and frequency analysis (or wavelet) coefficients of the signal or a section of the signal.

2. A method for saving the features corresponding to each class/source of sound in a highly reduced fashion, which has already encrypted the data.

3. A method for informing the user of the sound or acoustic event that may be required for safety, or for monitoring any space.

4. A method of analyzing sound, including the steps of:
Providing a sample of sound
Undertaking a wavelet or time-frequency analysis of the sample
Statistically analyzing the time-frequency coefficients
Classifying the analyzed sample using statistical descriptors such as mean and standard deviation, and
Classifying the analyzed sample according to band thresholds using iteratively determined coefficients.

5. A method as claimed in claim 1, 2 and 4, wherein the statistical analysis includes providing information about the distribution of energy across frequency bands.

6. A method as claimed in claim 1 or 2, wherein the mean coefficients are related to the time-averaged energy content in each band.

7. A method as claimed in claim 1 or 2, wherein the statistical descriptors such as variance and/or mean are related to the range of energy fluctuation over the length of the sample or section of the sample.

8. A method as claimed in claim 1, 2, 4 wherein the classifying is performed by the use of neural networks or statistical distance classifiers trained using the statistical properties (claim 6 and 7) of samples of each sound class.

9. A method as claimed in claim 1, 2, 3 further including the step of comparing the unknown sample to the necessary information of a sample signal of the source used during training of the system.

10. A method as claimed in claim 1, 2, 4 where the signal from a source is not required to be saved in the data base but only the statistical descriptors (such as mean and standard deviation) of some or all scales of the wavelet coefficients of the signal need to be saved.

11. A method as claimed in claimed in claim 1, 2, 4 where only the weights of the neural network of the network trained for the specific source needs to be saved.

12. A method of analyzing sound, including the steps of: providing a sample of sound, determining at least one frequency band attributable to the sample, analyzing the sample to provide coefficients related to the time-averaged energy content in each band and the range of energy fluctuation over the length of the sample.

13. A method of distinguishing the sound of concern for the user with hearing impairment using the above 1 to 13 for the purpose of assisting when the user is not wearing the hearing aid, or when the hearing aid is not appropriate.

14. A method of distinguishing the sound of concern for the user with need to monitor remote locations using the above 1 to 13 for the purpose of assisting to identify sounds for safety, security, for surveillance or other purposes.

15. A method as claimed in claim 12, wherein the distinguishing data or the weights of the training matrix is stored on smart cards or similar technology for real-time comparison.

16. A method as claimed in claim 12, where the method is used to identify the sound or other similar signal in the presence of other sounds or other similar signals based on the method described in claim 1.

17. A method as claimed in claim 1, where the method is used to identify the source of sound or similar signal for monitoring environmental noise or audio monitoring or other similar application.

18. A method claimed in claim 1, where the identification of sound is used to identify the possible signatures of machinery functioning (or malfunctioning) such as electrical transformers, automobiles and aircraft.

19. A method claimed in claim 1, where identifying sounds will be used to identify the possible speaker in telephone monitoring for security applications.

20. Apparatus adapted to analyze sound, said apparatus including:
a process or means adapted to operate in accordance with a predetermined instruction set, said apparatus, in conjunction with said instruction set, being adapted to perform the method as claimed in any one of claims 1 to 19. This includes a computer program product including a computer usable medium having computer readable program code and computer readable system code embodied on said medium for operation in association with a data processing system, said computer program product including computer readable code within said computer usable medium for analyzing sound according to any one of claims 1 to 19.

21. a. A method and an apparatus and/or device as herein disclosed.
